(19) United States
(12) Patent Application Publication
(10) Pub. No.: US 2002/0183119 A1
(43) Pub. Date: Dec. 5, 2002

(54) External game enhancer

(76) Inventor: Thomas Fessler, Mill Creek, WA (US)

Correspondence Address: Mark S. Beaufait, Esq., Black Lowe & Graham PLLC, 816 Second Avenue, Seattle, WA, 98104, US

(21) Appl. No.: 10/160,615

(22) Filed: May 30, 2002

Related U.S. Application Data
(60) Provisional application No. 60/294,802, filed on May 30, 2001.

(51) Int. Cl. A63F 9/24; G06F 17/00

(52) U.S. Cl. 463/47

(57) ABSTRACT

The present invention is an electronic game system including an electronic gaming platform. The electronic gaming platform includes an Input/Output link (“I/O link”). Connected to the I/O link is an external item, an external game enhancer, that contains storage memory accessible by the electronic gaming system. This storage memory stores game data or micro-code used by the electronic gaming platform during the operation of an electronic game. In one embodiment, the invention provides a small plug-in external item that can be quickly and directly connected to the electronic gaming platform. The external item may be incorporated in an action figure, doll, plush toy, toy vehicle, or consumer goods such as key chains, purses or backpacks.

### PRIORITY CLAIM

This application claims priority from U.S. Provisional Application No. 60/294,802, filed May 30, 2001.

### FIELD OF THE INVENTION

This invention relates generally to electronic games, and more specifically to plug-ins for electronic games.

### BACKGROUND OF THE INVENTION

Many electronic games, especially hand-held electronic games and electronic video games, have limited memory. Such games also often lack memory that is persistent or lasts after the power is turned off to the game. Thus, it is often difficult to personalize, modify, control, or add attributes or interact with the software application running on the gaming device, console system, personal computer or other such system or device, especially after power is turned off. Similarly, it is often cumbersome or difficult to save the status of a game when the gaming platform is turned off. Commonly, software application cards or cartridges for electronic games and the gaming platform itself, especially hand-held games and game cartridges, do not provide player or game accessible memory for saving game-created data, or supplemental information.

Many electronic video games utilize characters which are commanded or directed by the game player through the game software. The “personalization” or the characteristics and powers of the character may be fixed to a specified character, or may be modified or developed by the game player individually. In many existing games, it is often impossible for the game player to adopt or save particular character personalization, especially when a game is suspended or ended. Hand-held electronic games, the gaming platform, commonly have plug-in game cards or cartridges containing the software application for the desired game. Such cards or cartridges commonly do not have customized memory or persistent memory accessible by the player or the gaming platform.

Electronic video game characters are often offered as toy or collectable figurines. These figurines typically contain no link to their game counterpart, so specific features related to the figurine, or developed by the game player linked for the figurine character in the game, are not available for the game nor can they be stored by the game player. Game players cannot simply plug-in a figure or a character they have, or have developed, into existing electronic video games, especially hand-held games. Individual game players thus cannot separately carry with them character features or game memory, and plug them into a game system.

Therefore, there is an unmet need in the art for devices and systems, accessible by the platform game software, that combine character and game data storage, portability and plugability, and retain data after power to the game is turned off, or after a game is suspended.

### SUMMARY OF THE INVENTION

The present invention is an electronic game system including an electronic gaming platform. The electronic gaming platform includes an Input/Output link (“I/O link”). Connected to the I/O link is an external item, an external game enhancer that contains storage memory accessible by the electronic gaming system. This storage memory stores game data or micro-code used by the electronic gaming platform during the operation of an electronic game. In one embodiment, the invention provides a small plug-in external item that can be quickly and directly connected to the electronic gaming platform. The external item may be incorporated in an action figure, doll, plush toy, toy vehicle, or consumer goods such as key chains, purses or backpacks.

The present invention provides persistent data storage, character personalization, specialized data, executable code, and game status information for the electronic gaming platform.

### BRIEF DESCRIPTION OF THE DRAWINGS

The preferred and alternative embodiments of the present invention are described in detail below with reference to the following drawings.

FIG. 1 is a block diagram of the of the present invention.

FIG. 2 is a block diagram of the present invention configured for a hand-held electronic game and plug-in figurine.

FIG. 3 is a block diagram of the present invention configured for a personal computer and plug-in figurine.

### DETAILED DESCRIPTION OF THE PREFERRED EMBODIMENT

The present invention is an electronic game system including an electronic gaming platform. The electronic gaming platform includes an Input/Output link (“I/O link”). Connected to the I/O link is an external item, an external game enhancer that contains storage memory accessible by the electronic gaming system. This storage memory stores a data set used by the electronic gaming platform during the operation of an electronic game. In one embodiment, the invention provides a small plug-in external item that can be quickly and directly connected to the electronic gaming platform. The external item may be incorporated in an action figure, doll, plush toy, toy vehicle, or consumer goods such as keychains, purses or backpacks.

The present invention provides persistent data storage, character personalization, specialized data, executable code, and game status information for the electronic gaming platform.

The invention relates to a system and method to personalize, modify, control, add attributes to, or interact with, a software application running on a gaming platform. The gaming platform is suitably a hand-held gaming device, a console system, a personal computer, or any like system or device capable of playing an electronic game. The electronic game is suitably a video game, and with or without sound. The instant invention personalizes, modifies, controls, stores, and adds attributes and interacts with the software application with the use of an external item or plurality of external items. The external item may also include a controller controlling the action or personalization of a character in an electronic game.

The software application running on the gaming platform may be of any type written in a software language consistent with, and executed from, the gaming platform. This software may be embedded on a software storage device coupled to the gaming platform. The software application, for example, is stored on a hard drive, CD-Rom, microdrive, flash memory card, or embedded ROM memory card or device. The external item of the instant invention is typically a stand-alone item, separate from the gaming platform, which can be plugged and linked into the gaming platform through the I/O link. The stand-alone external item is any device capable of sending data to the gaming platform, or receiving and sending data to the gaming platform, and is commonly incorporated in or includes an action figure, doll, plush toy, toy vehicle, or consumer accessories such as key chains, purses, or backpacks.

In one embodiment, the external item permanently stores data for the software application running on the gaming platform or accepts and stores the data from the software application.

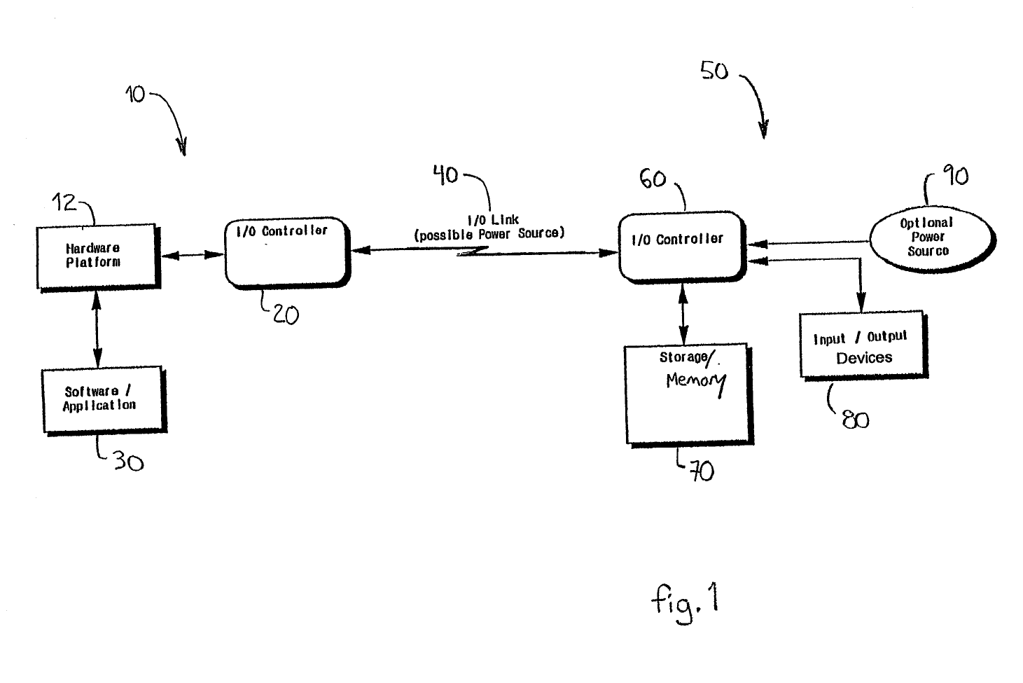

FIG. 1 is a block drawing showing an exemplary embodiment of the present invention. An external item 50 is linked through an I/O link 40 to a gaming platform 10.

The gaming platform 10 typically contains a hardware platform 12 executing microcode for a software application 30 for an electronic game. The software application is resident on the hardware platform or stored on a plug-in game cartridge or card. The gaming platform 10 includes a platform I/O controller 20 which controls links between the gaming platform 10 and the external item 50, and other linked devices. The platform I/O controller 20 is built into the hardware platform 12, or a separate plug-in or linked device. The software application 30 running on the hardware platform 10 accesses the external item 50 through the platform I/O controller 20. The platform I/O controller 20 is linked to an I/O link 40, that serves as the connection to the external item 50. The I/O link 40 allows communication of data between the software application and the external item 50. The communicated data may be executable software microcode stored in the external item 50 in a format compatible with the gaming platform 10 and the external item 50, or may be game-utilized data stored in a format compatible with the software application 30. The external item 50 in this embodiment includes an item I/O controller 60 which controls any data sent or received between the gaming platform 10 through the I/O link 40.

The item I/O controller 60 is linked to item storage memory 70. The item storage memory, by way of example is read-only-memory (“ROM”), random-access-memory (“RAM”), persistant RAM, static-random-access memory (“SRAM”), or flash RAM. In other embodiments, the memory is any suitable form of data storage.

The item I/O controller 60 is also linked to one or more user input/output devices 80. The user input/output devices 80 provide information to the game player, or permit input of information commands, or instructions from the game player. In the embodiment shown in FIG. 1, the external item 50 has an optional power source 90, which powers the external item 50, and is linked to the item I/O controller 60.

The I/O link 40 between the external item 50 and the gaming platform 10 allows data from the item storage memory 70 to be accessed by the software application 30 through the platform I/O controller 20, the I/O link 40, and the item I/O controller 60. The I/O link 40 coupling the external item 50 and the gaming platform 10 is typically a wired cable link, for example a Uniform Serial Bus (“USB”) or serial link cable coupling. However, those skilled in the art will recognize that the I/O link 40 may be any wired or wireless device capable of transmitting I/O data signals. By way of example, a wireless I/O link is an infrared link, 802.11, or a Bluetooth link. Examples of wired I/O links known in the art are serial cable, USB, or 1394 (Firewire). Also, by way of example, a wired link is a proprietary or custom game link or plug unique to the hardware platform 12 of the gaming device 10.

The external item 50 interacts with the gaming platform 10 in several ways, including the following exemplary methods.

The external item 50 accesses and executes through the I/O link 40 ROM stored data or software microcode from the external item 50 storage memory 70. The software microcode for example is software code to unlock a game character or object related to or resembling the exterior form, character, shape, or logo of the external item 50 in the software application 30 running on the hardware platform 12 of the gaming platform 10. The software microcode is accessed by commands from the software application 30, downloaded from the external item 50 storage memory 70 and executed with the software application 30 on the gaming platform 10.

Alternately, the gaming platform 10 accesses and executes through the I/O link 40 persistent RAM stored game-utilized data in the item storage memory 70 of the external item 50. The persistent RAM stored game-utilized data is created or maintained by the software application 30 running on the gaming platform 10. Such data is personalization data for a character or object that is included in the electronic game, such as features or magical powers, or status information regarding the game, its characters, and the game player's score. In another embodiment, the stored game-utilizied data includes displacement, acceleration, and orientation data relating to the external item 50 in a spatial context within the electronic game. For example, the stored data reflects that a toy or collectible figurine into which the external item is molded is moving in a particular direction at a particular speed in the game when suspended. This information is input by the gameplayer by physical movement and manipulation of the external item 50/figurine including orientation, movement, and accelleration sensors as user input/output devices 80.

In further embodiments, the external item 50 allows access to and execution through the I/O link 40 of additional methods of input and output of information to and from the game player. For example, a light or sound on the external item 50 may be activated by software code executed by the gaming platform 10.

In another example, the external item 50 through the I/O link 40 provides feedback or information to the software application 30 with the external item 50, being used, for example through manipulation or motion, as a controller for the gaming platform 10.

In each of these examples, the software application 30 running on the hardware platform 12 of the gaming platform 10 communicates through the platform I/O controller 20, and the I/O link 40, with the external item 50. The software application 30 then executes software microcode provided by stored data in the item storage memory 70, or utilizes game-utilized data stored in the item storage memory 70.

Commonly, the hardware platform 12 of the gaming platform 10 contains a microprocessor for processing and executing software code. The software code executed by the hardware platform 12 often includes an operating system for the hardware platform 12, and code for the game that is the source of the interaction between the player and the gaming platform 10. The gaming platform 10 will typically include a display for visual feedback of images generated by the software application 30 for the player. The gaming platform 12 typically has capabilities for accepting commands directly, such as through push buttons or joysticks, or through other devices coupled to the gaming platform 10, such as a keyboard. The gaming platform 10 may accept commands by any number of other means well-known in the art, for example by voice commands interpreted by the software code executed on the gaming platform 10.

An embodiment of the external item 50 includes a microprocessor that performs the functions of the item I/O controller 60, as well as other functions. The item I/O controller 60 or any microprocessor in the external item 50 controlling the external item 50 input/output processes executable software code received from the gaming platform 10, or from the external item 50 item storage memory 70.

The external item 50 in FIG. 1 has additional user input/output devices 80. It will be appreciated that any suitable device for game input and output may be included in the external item 50.

The external item 50 in this embodiment in FIG. 1 is powered by an item power source 90. The power source by way of example, may be a conventional self-contained battery pack, or a plug-in DC power source. An example embodiment of the present invention is its use in a role-playing software game executed on a gaming platform 10.

The gaming platform 10 and the hardware platform 12 is any number of platforms. These platforms include hand-held gaming devices, personal computers, such as a Windows operating system personal computer, other hardware platforms or any suitable gaming devices, console systems, game boxes or other personal computers. In this instance, the software application 30 is a role-playing game incorporating various levels of game play in the software microcode (not shown). Higher game levels are reached by completion of one level at a time. The successful completion of one level leads to the start of a new level. The levels are filled with puzzles and challenges inherent in such electronic games. For example, a player may need to interact with the game using the keypad or other input device to move his or her on-screen character through a maze. Successful progression through the maze moves the player to the next level. Thus, the player begins with level 1, and proceeds through levels 2 and higher as the game progresses. The game might then present to the player a challenge, for example to “move the sword with the magical sword movement.” An external item 50 configured as a toy sword, linked to the gaming platform 10, could then be moved by the player in various motions, perhaps based on clues given to the game player during game play. When the player completes the sword movement, the software application 30 allows the player to move to another level, and the sword lights up, alerting the player that the player can move on to the next level. It will be understood by those skilled in the art that the interaction between the player and the external item 50 can occur at any level, and is not necessarily tied directly to movement to the next game level.

A further exemplary embodiment of the instant invention is an external item 50 where the I/O link 40 is a plug inserted directly into a socket on the gaming platform 10, and the external item 50 is a small electronic chip package including the item I/O controller 60, and the item storage memory 70. The external item 50 in this embodiment is quite small, approximately the size of a keychain emblem. This embodiment is powered by power received from the gaming platform 10 through the I/O link 40, rather than through a separate item power source 90. This embodiment contains no separate user input/output devices 80. This embodiment uses a programmable logic chip as the item I/O controller 60 and a Flash RAM chip as the item storage memory 70. The programmable logic chip is an 8 bit RISC microprocessor, an ATMEL AT Tiny 12, or suitable logic device. The ATMEL AT Tiny 12 contains a software universal asynchronous receiver-transmitter (“UART”), drivers for reading/writing to the item storage memory 70, a unique serial id number, and a command interpreter. The UART is configured with FIFO enables, and no additional hardware handshaking. The item storage memory chip is a 1 megabit ATMEL data flash memory chip, AT45D011, or any suitable memory device. In this embodiment, the memory chip is a serial memory device, and is half duplex. The item storage memory is divided into pages of 256 bytes. The smallest amount of data that can be read from or written to is a page. The number of pages available is a function of the size of the memory.

Basic command functions of the item I/O controller 60, include getting the controller identification name and serial identification (“Get Device ID”), requesting status of the controller, whether, buzy or ready, and available memory capacity (“Get Device Status”), setting the controller to select and access a particular read/write memory page (“Set Memory Page”); reading a page from available memory (“Read Memory Page”); writing a page into available memory (“Write Memory Page”); and rewriting the serial identification code of the controller, usually not accessed by the game software, with a password required (“Write Device Serial Code.”). In this embodiment the command sequence is a 3 byte command, consisting of a signal code saying a command is coming, a single byte command code, and a 1 byte checksum.

The Read Memory Page operation includes checking to see if the item I/O controller 60 is buzy, setting the memory page to read, sending read commands to the memory chip, reading the memory, byte by byte, 256 times to read the entire memory page from the item storage memory 70, calculating a checksum of the data read, and comparing the checksum from memory. A successful Read Memory Page returns an “ok” message, and an unsuccessful Read Memory Page returns an “error” message.

The Write Memory Page operation includes checking to see if the item I/O controller 60 is busy, setting the memory page to write, writing the memory, 8 bytes at a time, 32 times, reading a checksum from the item storage memory 70, and comparing the checksum. A successful Write Memory Page returns an “ok” message, and an unsuccessful Write Memory Page returns an “error” message.

Data written to and read from memory is game-utilized data and software microcode used to supplement the software application 30 microcode. The software application 30 running on the gaming platform 10 includes microcode to access the external item 50 and send commands to its item I/O controller 60 to perform the listed operations. The software application 30 then utilizes pre-programed data returned from the external item 50 or data the software application 30 stored on the external item for the operation of the game by the player.

In other embodiments, larger or smaller capacity memory devices are used. In further embodiments, the I/O controller 60, and the item storage memory 70 are on a single device. For example, the ATMEL AT Tiny 12 contains 64 bytes of available storage memory. This memory is large enough to store a 16 digit game status code or “password”. In an embodiment of the present invention, this memory is used to capture and store the status of a single game that is suspended, without the necessity of a separate memory device.

The item I/O controller 60 communicates with the gaming platform 10 using any suitable communications protocol. In one embodiment, a serial protocol is used, with baud rate set at 9600 baud, and 1 start bit, 1 stop bit, 8 data bits, and no parity.

It will be appreciated that a wide variety of circuits and programming may be utilized to perform the functions of this embodiment and the other embodiments of the present invention. In an exemplary embodiment, the external item 50 connects directly with a handheld game that serves as the gaming platform 10. This embodiment stores game status information for between one and forty sets of game status data, saving, for example, data specifying the player game level and score when the game was suspended.

The external item 50 is thus a very portable plug-in item that may be readily carried by the game player separate from the gaming platform 10. The external item 50 may be plugged into any gaming platform 10 with a matching plug serving as the I/O link 40. This permits the game player to carry the external item to any number of locations and plug it into alternate gaming platforms 10, such as a friend's gaming platform 10.

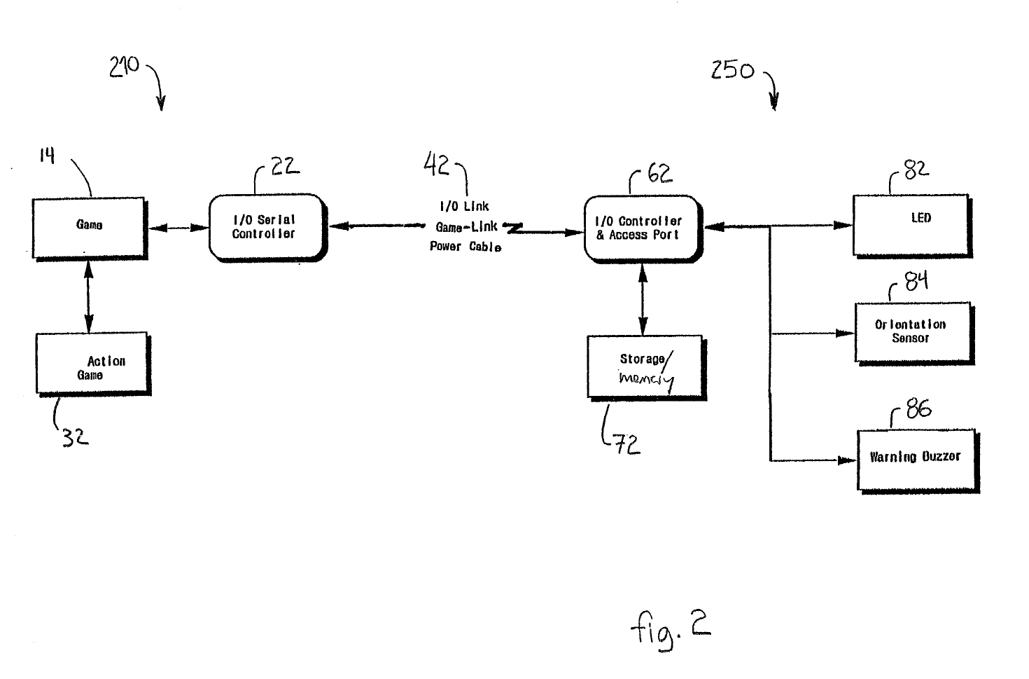

FIG. 2 is a block diagram of an embodiment of the instant invention where the external item 250 is incorporated into an action figure (not shown) and the gaming platform 210 is a hand-held game 14. The gaming platform 210 includes the hand-held game 14 serving as the hardware platform running an action game 32 serving as the software application. The hand-held game includes a platform I/O serial controller 22, serving as the platform input/output controller. The gaming platform 210 through the platform I/O serial controller 22 is linked to the external item 250 through a game-link power cable 42 serving as the input/output link. In one embodiment of the instant invention, the game-link power cable 42 is a proprietary form I/O link plug. The game-link power cable 42 alternately may include a flexible cable. The external item 250 in this embodiment is a toy action figure.

An exemplary action figure is the game character from any character game that may be played on a handheld game device. It will be appreciated that the present invention is incorporated into figures or consumer goods to match a wide variety of game characters, carrying a wide variety of information concerning such characters. The external item 250 includes an item I/O controller & access port 62, linked to the game-link power cable 42 and configured to control information transferred back and forth between the gaming platform 210 and the external item 250. The item I/O controller & access port 62 is linked to item ROM storage 72 storing information concerning the game character represented by the action figure incorporating the shape of the external item 250. When the external item 250, with the action figure, is plugged into the gaming platform 210, the player is permitted to access the character represented by the external item 250, for example the a named proprietary game character. Alternately, when the external item 250 is plugged into the gaming platform 210, the game character is given additional or magical characteristics of the action figure character to assist the player in playing the action game 32.

In a further special mode, the external item 250 permits the player to use the external item 250 to control the on-screen game character as it flies around in game levels. For example, by using an optional orientation sensor 84, linked to the item I/O controller and access port 62, in the external item 250 to control the game, the player may control character movement on the display of the gaming platform 210. The orientation sensor 84 orients and maps motion coordinates to the action game 32 running on the gaming platform 210 through the game-link power cable 42. The action game 32 then conforms the character coordinates on the gaming platform 210 to the motion and coordinates of the external item 250 as the player moves and steers the external item 250 action figure. Optional inputs and outputs such as a light emitting diode 82 or a warning buzzer 86 may be added to show an active connection with the hand-held game 14 or transfer other information or signals to the game player. These devices may alert the game player of events before they happen in the game by alerting the player of upcoming sequences in the action game 32 software code playing on the gaming platform 210. For example, software code in the action game 32 may activate the LED 82 of the external item 250 when the game player interacts with the action game 32 in a manner warranting sending an alert signal to the player. Similar interactions between the player and the action game 32 may, for example, trigger a warning buzzer 86, connected to the gaming platform 210, through the game-link power cable 42, and the item I/O controller & access port 62 of the external item 250. The orientation sensor 84 in the external item 250 utilized to control the action game 32, is also linked to the gaming platform 210 through the item I/O controller and access port 62 of the external item 250, which is in turn connected through the game-link power cable 42 to the gaming platform 210. Alternative user input/output devices, by way of example, include lights, sound devices, sound sensors, joysticks or touch sensors.

The item ROM storage 72 of the external item 250 may contain a wide variety of data, including executable code, adding features to the game, personalization to the characters, or restoring game status information. In this exemplary embodiment, this data relates to the character of the toy action figure incorporating the external item 250.

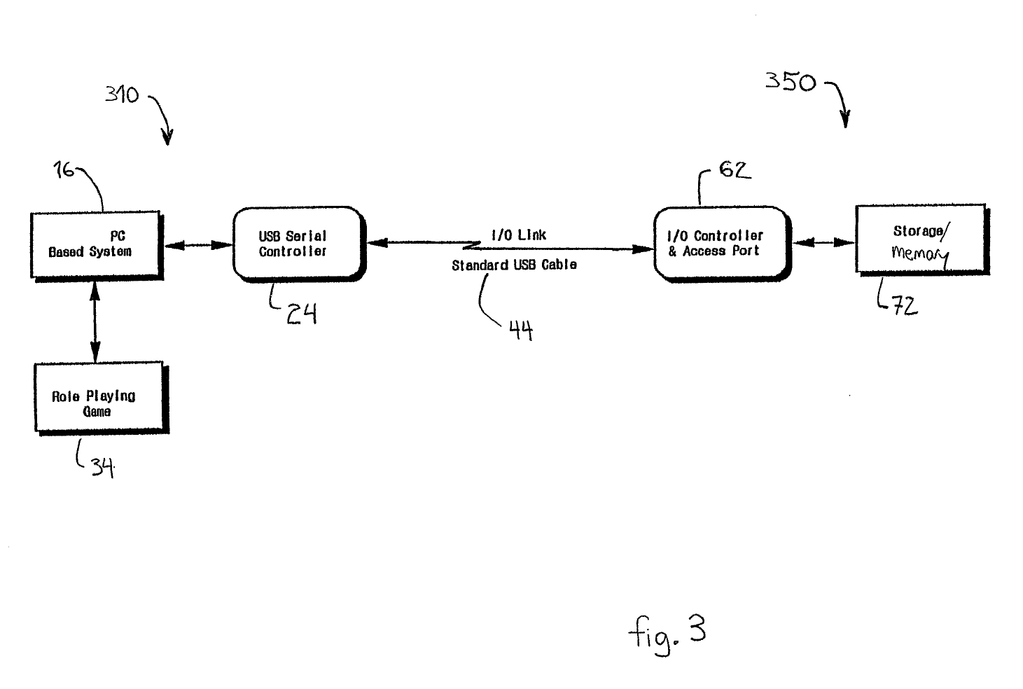

FIG. 3 shows a block diagram of the instant invention configured for a personal computer based game system, with an external item 350 configured as a figurine that carries a special new character to the gaming platform 310 for use in a role-playing game 34. The gaming platform 310 includes a personal computer PC system 16 with a platform Uniform Serial Buss (“USB”) serial controller 24. The PC system operates the role-playing game 34 as its application software. One example of a role-playing game is a fantasy action role-playing game where the game player becomes a particular fantasy character and acts in that role in the role-playing game 34. Through a USB cable 44, the gaming platform 10 is connected to the external item 350. The external item 350 is a fantasy collectable figurine including an item I/O controller & access port 62 linked to item ROM storage 72. The item ROM storage 72 permits the player to access the game counter part of the fantasy collectible figurine, abilities in the role-playing game 34. This counterpart otherwise would not be available to a player without the external item 350 fantasy collection figurine. The counterpart character with special abilities comes directly with the external item 350. Such features could not be accessed by a pirating user. It is not available through obtaining an access code activating a feature in the role-playing game 34, because the software code for the hidden character and abilities are located on the item ROM storage 72, not in the role playing game 34. This information must be transmitted through the USB cable to the gaming platform to operate. The external item 350 thus brings custom characters and custom personalization to the role playing game 34 for use by the player.

Any of the embodiments of the present invention may also carry special data, such as marketing data or contest data, which is accessed by the player when the player connects the external item 350 to the gaming platform 310. For example, a contest code number or code character may be included in the item ROM storage 72 of the external item 350. This information is released to the player through the gaming platform 310 when the external item 50 is connected with the gaming platform 10. In the contest example, the player may then compare that player's game display with a shipping box of the external item 350 to determine whether the player is a contest winner.

In the present invention, communication between the external item 350 and the gaming platform 310 through the USB cable 44, or other input/output links in other embodiments, may be kept proprietary through the mandatory exchange of copyrighted handshaking codes as precursor to communications between the external item 350 and the gaming platform 310.

It will be appreciated that the external item of the present invention may be incorporated with a wide variety of consumer goods from toys to key chains, backpacks, and purses. The external item may be programmed to carry with it special information related in some way to the consumer goods or the marketing features and characters incorporated into the consumer goods that are then activated when the external item is connected to the gaming platform. For example, a fantasy character logo key chain incorporating the external item may carry that fantasy character's characteristics into a game when the key chain is connected to the gaming platform. Similarly, a backpack or purse incorporating a character logo or game situational designs or landscapes could communicate character personalization or situational information into the gaming platform matching the shape, design, logo, or graphical art of the consumer good. Any one or more of the features and data sets described above may be included into an external item incorporated into a consumer good.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An electronic game system comprising:
an electronic gaming platform, including an i/o link, arranged to execute an electronic game;
an external item detachably linked through the i/o link to the electronic gaming platform, wherein the external item includes an item storage memory accessible to the electronic gaming platform, and the item storage memory stores a data set accessed by the electronic gaming platform in the execution of the electronic game; and
computer code instructing the electronic gaming platform to recognize and communicate with the external item.

2. The system of claim 1, wherein the item storage memory comprises at least one of ROM, RAM, SRAM, and Flash RAM.

3. The system of claim 1, wherein the data set includes computer code executable by the electronic gaming platform in the operation of the electronic game.

4. The system of claim 1, wherein the data set includes a set of contest data accessed by the gaming platform.

5. The system of claim 1, wherein the data set includes a set of personalization data accessed by the gaming platform in the operation of an electronic game.

6. The system of claim 1, wherein the data set includes a set of game data reflecting the status of the electronic game.

7. The system of claim 1, wherein the external item further includes:
an item i/o controller, connected with the i/o link and the item storage memory, arranged to control access by the electronic gaming platform to the data set.

8. The system of claim 7, wherein the item i/o controller is further connected to at least one user input/output device.

9. The system of claim 1, wherein the external item further includes:
at least one user input/output device, accessible through the i/o link.

10. The system of claim 9, wherein the at least one user input/output device includes:
an led display.

11. The system of claim 9, wherein the at least one user input/output device includes:
a warning buzzer.

12. The system of claim 9, wherein at least one user input/output device includes:
an orientation sensor.

13. The system of claim 9, wherein at least one user input/output device includes:
a motion detector.

14. The system of claim 1, wherein the external item further includes:
a power source, arranged to provide electrical power to the external item.

15. The system of claim 1, wherein the i/o link includes:
a power link arranged to transmit electrical power from the gaming platform to the external item.

16. The system of claim 1, wherein the external item further includes a figurine.

17. An external item for linking to an electronic gaming platform, the external item comprising:
an i/o port, arranged to detachably link to an electronic gaming platform executing an electronic game;
an item i/o controller, connected to the i/o port, and arranged to communicate through the i/o port with the electronic gaming platform;
item storage memory, connected to the item i/o controller, and arranged to communicate with the item i/o controller; and
a data set stored within the item storage memory accessed by the electronic gaming platform in the operation of the electronic game.

18. The external item of claim 17, wherein the data set includes a set of program steps executed by the electronic gaming platform in the operation of the electronic game.

19. The external item of claim 17, wherein the data set includes a set of contest data accessed by the electronic gaming platform.

20. The external item of claim 17, wherein the data set includes a set of character personalization data accessed by the electronic gaming platform in the operation of an electronic game.

21. The external item of claim 17, wherein the data set includes a set of game data reflecting the status of the electronic game.

22. The external item of claim 17, wherein the external item further includes:
at least one user input/output, arranged to communicate with the electronic gaming platform.

23. The external item of claim 1, wherein the external item further includes a figurine.

24. A hand-held game system comprising:
a hand-held gaming platform, arranged to execute an electronic game;
a dedicated game i/o link linked to the hand-held gaming platform;
a hand-held external item detachably linked to the dedicated game i/o link, wherein the hand-held external item includes an item storage memory accessible by the hand-held gaming platform through the dedicated game i/o link, and the item storage memory stores a data set accessed by the hand-held gaming platform in the operation of the electronic game; and
computer code instructing the hand-held gaming platform to recognize and communicate with the hand-held external item.

25. The system of claim 24, wherein the data set includes a set of personalization data accessed by the hand-held gaming platform in the operation of the electronic game.

26. The system of claim 24, wherein the data set includes a set of game data reflecting the status of the electronic game.

27. The system of claim 24, wherein the hand-held external item further includes:
an item i/o controller, connected with the dedicated game i/o link and the item storage memory, and arranged to control access by the electronic gaming platform to the data set.

28. The system of claim 27, wherein the item i/o controller is further connected to at least one user input/output device.

29. The system of claim 24, wherein the external item further includes a figurine, shaped to communicate a personalization of a game character to a game player.

30. A method for enhancing an electronic game comprising:
attaching an external item to an electronic gaming platform executing an electronic game;
storing a data set for the electronic game on the external item;
recognizing a connection between the electronic gaming platform and the external item;
controlling input and output between the electronic game and the external item using an item I/O controller controlling an input/output link;
communicating the data set between the electronic gaming platform and the external item utilizing the input/output link; and
utilizing the data set in the operation of the electronic game.

31. The method of claim 30, wherein the data set includes a set of personalization data utilized by the gaming platform in the operation of an electronic game.

32. The method of claim 30, wherein the data set includes a set of game data reflecting the status of the electronic game.

33. The method of claim 30, further comprising:
inputting and outputting user information through at least one user input/output included in the external item.

34. The method of claim 30, further comprising:
representing a character in the electronic game by a figurine included in the external item.

35. The method of claim 30 wherein the electronic gaming platform is a hand-held gaming platform.
